(19) United States
(12) Patent Application Publication
(10) Pub. No.: US 2005/0174296 A1
(43) Pub. Date: Aug. 11, 2005

(54) Antenna and wireless communications device having antenna

(76) Inventor: Hironori Okado, Gunma-Gun (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/037,298

(22) Filed: Jan. 18, 2005

(30) Foreign Application Priority Data
Feb. 10, 2004 (JP) 2004-032994

(51) Int. Cl. H01Q 9/28

(52) U.S. Cl. 343/795; 343/700 MS

(57) ABSTRACT

An antenna includes a dielectric substrate having an antenna element for the 5 GHz band and an antenna element for the 2.4 GHz band; a ground pattern provided in association with the antenna element for the 5 GHz band on a feeding-point side of the antenna element for the 5 GHz band, the ground pattern having a length, along a longitudinal direction, equivalent to a quarter of a wavelength of the 5 GHz band; a first parasitic element provided in association with the antenna element for the 2.4 GHz band; and a second parasitic element provided on a surface opposite to a surface where the ground pattern is provided, the second parasitic element being provided so as to overlap both the antenna element for the 5 GHz band and the ground pattern.

### BACKGROUND OF THE INVENTION

1. Field of the Invention

The present invention relates to an antenna and a radio communications device provided with the antenna.

2. Description of the Related Art

Along with the recent spread of local area networks (LANs), notebook personal computers or personal digital assistants (PDAs) with wireless LAN functions become available. In order to incorporate antennas for wireless LANs in such small devices, the antennas must be miniaturized.

Japanese Unexamined Patent Application Publication No. 2001-168625 discloses a radio communications device provided with a chip antenna and a ground pattern mounted on a printed board in a cover of a notebook personal computer that includes a liquid crystal display, the ground pattern having a total circumferential length approximate to a wavelength of the radio communications frequency band. According to the techniques, since the ground pattern is to be provided overlapping the rear surface of the liquid crystal display, further reduction in size is not required. Furthermore, supporting dual bands is not considered.

Japanese Unexamined Patent Application Publication No. 2002-73210 discloses techniques for providing a plurality of antennas that enables to adapt a plurality of radio communications systems on an upper part of a liquid crystal panel of a portable information device. However, a total circumferential length of a ground pattern of the antennas is chosen to be wavelength of the frequency band times 0.8 to 1.25, for example, 20 mm×45 mm in the case of the 2.4 GHz band. According to the technique, since the ground pattern is provided overlapping the rear surface of a liquid crystal display panel, further reduction in size is not required. Furthermore, a plurality of large antennas is required in order to support adapt a plurality of radio communications systems.

Japanese Unexamined Patent Application Publication No. 2002-151928 discloses techniques for incorporating an antenna in an upper part of a liquid crystal panel of a portable electronic device. According to the techniques, the total circumferential length of a grounding conductor must be approximate to one wavelength of a radio frequency. More specifically, it is chosen to be in a range of approximately 0.7 to 1.4 times the wavelength, preferably in a range of approximately 0.8 to 1.25 times the wavelength, and more preferably in a range of approximately 0.85 to 1.05 times the wavelength. Thus, in the case of a frequency band from 2,400 MHz to 2,483.5 MHz, the size of a grounding conductor is, for example, 20 mm×45 mm, 20 mm×25 mm, or 20 mm×35 mm. According to the techniques, since the grounding conductor is provided overlapping the rear surface of the liquid crystal panel, further reduction in size is not required.

Japanese Unexamined Patent Application Publication No. 2002-330025 discloses an antenna device provided with a feed radiating electrode branched into two branched radiating electrodes is provided on a surface of a base and grounded parasitic radiating electrodes are disposed in proximity to the respective branched radiating electrodes. Since the parasitic radiating electrodes are connected to ground, substantially, what is disclosed is only the relationship between the ground and the feed radiating electrode. Furthermore, since the ground connected to the parasitic radiating electrodes is connected to the ground of the circuit board, the size of the ground is very large.

According to techniques disclosed in Japanese Unexamined Patent Application Publication No. 2000-278025 and Japanese Unexamined Patent Application Publication No. 2001-313516, a first dipole element that resonates at a first frequency is provided on both sides of a dielectric substrate, and a second dipole element that resonates at a second frequency is formed by a cutout provided in the first dipole element. Similarly, third to n-th dipole elements are formed. Furthermore, among the first to n-th dipole elements, in order to increase the bandwidth of one or more frequency bands, a parasitic element is disposed in parallel to the dipole element that resonates at the relevant frequency on an upper side, left side, right side, or on left and right sides of the dipole element. Although usage of a parasitic element is disclosed, reduction in the size of a ground pattern is not considered.

Japanese Unexamined Patent Application Publication No. 2001-298313 discloses a surface-mounted antenna that supports multiple frequency bands. In the antenna, a feed element and a parasitic element are disposed with a gap therebetween on a surface of a dielectric substrate. However, the parasitic element is connected to a ground terminal, so that substantially, what is disclosed is only the relationship between the ground and the feed element. Furthermore, since the ground terminal is connected to the ground of a circuit board, reduction in the size of a ground pattern is not considered.

According to the related arts described above, reduction in the size of an antenna as a whole including a ground pattern has its limitations. Furthermore, although some documents disclose use of a parasitic element, reduction in the size of an antenna as a whole is not sufficient.

### SUMMARY OF THE INVENTION

Accordingly, it is an object of the present invention to provide techniques for reducing the size of an antenna while maintaining sufficient characteristics.

Another object of the present invention to provide a small dual-band antenna having sufficient characteristics.

Another object of the present invention to provide techniques for including a small antenna having sufficient characteristics in an electronic apparatus.

According to an aspect of the present invention, an antenna is provided. The antenna includes an antenna element for a predetermined frequency band; a ground pattern provided in association with the antenna element on a feeding-point side of the antenna element, the ground pattern having a length, along a longitudinal direction, less than a quarter of a wavelength corresponding to the predetermined frequency band; and a parasitic element provided in proximity to the antenna element. Usually, a ground pattern having a length equivalent to a quarter of a wavelength corresponding to a frequency band of an antenna element is needed. In contrast, according to the aspect of the present invention, since a parasitic element is provided, the size of a ground pattern can be reduced compared to usual size, and thus the size of the antenna as a whole can be reduced.

Preferably, the parasitic element has a length, along a longitudinal direction, less than a quarter of a wavelength corresponding to the predetermined frequency band. This allows further reduction in the size of the antenna as a whole.

The antenna element described above may be formed on a dielectric substrate. This allows further reduction in the size of the antenna as a whole.

According to another aspect of the present invention, an antenna is provided. The antenna includes a substrate having a first surface and a second surface opposite to the first surface; an antenna element for a predetermined frequency band, provided on a first-surface side of the substrate; a ground pattern provided on the first-surface side of the substrate, the ground pattern being provided in association with the antenna element on a feeding-point side of the antenna element; and a parasitic element provided on a second-surface side of the substrate so as to overlap both the antenna element and the ground pattern. Since the parasitic element is provided so as to overlap both the antenna element and the ground pattern, characteristics can be improved, and the size of the antenna as a whole can be reduced.

Preferably, the parasitic element has a length, along a longitudinal direction, less than a quarter of a wavelength corresponding to the predetermined frequency band. Even such a small parasitic element is effective to improve antenna characteristics.

Also preferably, the ground pattern has a length, along a longitudinal direction, equivalent to a quarter (including substantially or nearly a quarter) of a wavelength corresponding to the predetermined frequency band. As the predetermined frequency band becomes higher, the wavelength becomes shorter, so that the length of the ground pattern also becomes shorter accordingly.

Furthermore, the antenna element described above may be formed on a dielectric substrate. This allows further reduction in the size of the antenna as a whole.

According to another aspect of the present invention, an antenna is provided. The antenna includes a first antenna element for a first frequency band; a second antenna element for a second frequency band that is lower than the first frequency band, the second antenna element being connected to the first antenna element; a ground pattern provided in association with the first antenna element on a feeding-point side of the first antenna element, the ground pattern having a length, along a longitudinal direction, equivalent to a quarter (including substantially or nearly a quarter) of a wavelength corresponding to the first frequency band; and a first parasitic element provided in proximity to the second antenna element. The ground pattern having a length equivalent to a quarter of a wavelength corresponding to the first frequency band is too short for the second antenna element for the second frequency band, which is lower than the first frequency band. However, since the first parasitic element is provided, capacitive coupling occurs between the second antenna element and the first parasitic element. Thus, the second antenna element causes excitation of the first parasitic element. Accordingly, sufficient characteristics are achieved in the second frequency band even though the ground pattern is short. In the above, no second parasitic element may be provide in proximity to the first antenna element, especially in an embodiment where the first antenna element is constituted by a tabular element whereas the second antenna is constituted by a linear element.

The antenna may further include a substrate having a first surface and a second surface opposite to the first surface, the first antenna element, the second antenna element, and the ground pattern being provided on a first-surface side of the substrate; and a second parasitic element provided on a second-surface side of the substrate so as to overlap both the first antenna element and the ground pattern. This allows tuning of impedance by a capacitive component that occurs between the second parasitic element and the ground pattern and the first antenna element and by an inductive component attributable to the length of the second parasitic element. This serves to improve antenna characteristics.

Preferably, the first parasitic element has a length, along a longitudinal direction, less than a quarter of a wavelength corresponding to the second frequency band. This allows reduction in the size of the antenna as a whole.

Also preferably, the second parasitic element has a length, along a longitudinal direction, less than a quarter of a wavelength corresponding to the first frequency band. Antenna characteristics can be sufficiently improved even when the second parasitic element is short.

The first antenna element and the second antenna element may be formed on a dielectric substrate. This allows reduction in the size of the antenna as a whole.

The first antenna element and the second antenna element may be such that the first antenna element have edges whose distances to the ground pattern continuously change and that the second antenna element is connected to the middle of a top portion of the antenna element. This allows achieving favorable characteristics independently for each of the first and second frequency bands.

According to another aspect of the present invention, a radio communications device including an antenna is provided. The antenna includes an antenna element for a predetermined frequency band; a ground pattern provided in association with the antenna element on a feeding-point side of the antenna element, the ground pattern having a length, along a longitudinal direction, less than a quarter of a wavelength corresponding to the predetermined frequency band; and a parasitic element provided in proximity to the antenna element. The ground pattern is separated from a ground of a housing of the radio communications device. Since the ground pattern is separated from the ground of the housing of the radio communications device, it is possible to design the antenna independently of the radio communications device. Thus, customization for the individual radio communications device can be minimized, so that the efficiency of design is improved.

According to another aspect of the present invention, a radio communications device including an antenna is provided. The antenna includes a substrate having a first surface and a second surface opposite to the first surface; an antenna element for a predetermined frequency band, provided on a first-surface side of the substrate; a ground pattern provided on the first-surface side of the substrate, the ground pattern being provided in association with the antenna element on a feeding-point side of the antenna element; and a parasitic element provided on a second-surface side of the substrate so as to overlap both the antenna element and the ground pattern. The ground pattern is separated from a ground of a housing of the radio communications device.

According to another aspect of the present invention, a radio communications device including an antenna is provided. The antenna includes a first antenna element for a first frequency band; a second antenna element for a second frequency band that is lower than the first frequency band, the second antenna element being connected to the first antenna element; a ground pattern provided in association with the first antenna element on a feeding-point side of the first antenna element, the ground pattern having a length, along a longitudinal direction, equivalent to a quarter of (including substantially or nearly a quarter) a wavelength corresponding to the first frequency band; and a parasitic element provided in proximity to the second antenna element. The ground pattern is separated from a ground of a housing of the radio communications device. In all of the aforesaid aspects, any element used in an aspect can interchangeably be used in another aspect unless such a replacement is not feasible or causes adverse effect.

According to at least one embodiment of the present invention described above, it is possible to implement a smaller antenna while maintaining sufficient characteristics.

Furthermore, according to at least one embodiment of the present invention described above, it is possible to provide a small dual-band antenna having sufficient characteristics.

Furthermore, according to at least one embodiment of the present invention described above, it is possible to integrate a small antenna having sufficient characteristics in an electronic apparatus.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1A is a top view, FIG. 1B is a side view, and FIG. 1C is a rear view, of an antenna according to an embodiment of the present invention. The figure does not intend to proportionately show dimensions of each element but simply shows general configurations solely for illustrative purposes.

FIG. 2 is a graph showing frequency characteristics of the antenna according to the embodiment.

FIG. 3 is a graph showing characteristics of the antenna according to the embodiment with a second parasitic element removed therefrom.

FIG. 4 is a graph showing characteristics of the antenna according to the embodiment with first and second parasitic elements removed therefrom.

FIG. 5 is a graph showing frequency characteristics of the efficiency of the antenna according to the embodiment.

FIGS. 6A to 6D are diagrams showing radiation directivity characteristics of the antenna according to the embodiment.

FIG. 7 is a schematic diagram showing an example where the antenna according to the embodiment is mounted on a notebook personal computer. The figure does not intend to proportionately show dimensions of each element but simply shows general configurations solely for illustrative purposes.

FIG. 8 is a graph showing frequency characteristics of the antenna according to the embodiment as mounted on a notebook personal computer.

FIG. 9 is a graph showing frequency characteristics of the antenna according to the embodiment is mounted on a notebook personal computer.

### DESCRIPTION OF THE PREFERRED EMBODIMENTS

The present invention will be explained with respect to preferred embodiments. However, the present invention is not limited to the preferred embodiments. Dimensions or other numbers indicated in the embodiments are approximate or typical numbers and generally the numbers can vary in other embodiments by ±50%, for example.

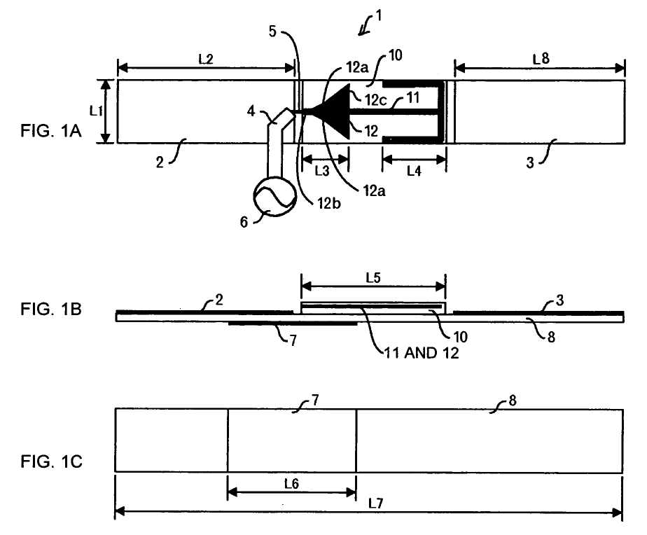

FIGS. 1A to 1C show the configuration of an antenna according to an embodiment of the present invention. An antenna 1 is, for example, a dual-band antenna that allows communications in two frequency bands, namely, the 2.4 GHz band (an operating frequency band of 2.4 GHz to 2.5 GHz and a center frequency of 2.45 GHz) and the 5 GHz band (an operating frequency band of 4.9 GHz to 5.8 GHz and a center frequency of 5.4 GHz) used in wireless LANs. The operating frequency bands are not limited to the above and one of ordinary skill in the art could readily select one or two or more of operating frequency bands depending on the intended purposes or the applicable configuration. The antenna 1 includes a substrate 8, which is, for example, an FR-4 printed circuit board; a ground pattern 2 provided on an upper surface of the substrate 8; a dielectric substrate 10 provided on the upper surface of the substrate 8, the dielectric substrate 10 having an antenna element 12 for the 5 GHz band and an antenna element 11 for the 2.4 GHz band; a first parasitic element 3 provided on the upper surface of the substrate 8; a second parasitic element 7 provided on a lower surface of the substrate 8; a coaxial cable having a core wire 5 connected to a feeding point 12b of the antenna element 12 for the 5 GHz band and having a shield connected to the ground pattern 2; and a radio-frequency power source 6 connected to the coaxial cable 4.

FIG. 1A is a top view of the antenna 1. As described above, on the upper surface of the substrate 8, the ground pattern 2, the dielectric substrate 10, and the first parasitic element 3 are provided. The ground pattern 2 has a length L2 of 14 mm and a width L1 of 4 mm. The length L2, i.e., 14 mm, is substantially or nearly a quarter of a wavelength corresponding to 5.4 GHz. Usually, the length L2 of the ground pattern 2 is optimized in accordance with the center frequency of the lower frequency band. A quarter of a wavelength corresponding to the center frequency 2.45 GHz of the 2.4 GHz band is approximately 31 mm. When the length L2 of the ground pattern 2 is chosen to be equivalent to a quarter of the wavelength corresponding to 2.45 GHz, favorable characteristics are achieved in the 2.4 GHz band. However, in the 5 GHz band, since the length L2 of the ground pattern 2 is approximate to one half of the wavelength corresponding to the center frequency 5.4 GHz, stable characteristics are not achieved, and characteristics considerably vary in the operating frequency band. In this embodiment, the length L2 of the ground pattern 2 is optimized in accordance with the center frequency 5.4 GHz of the higher 5 GHz band, so that the length L2 is shorter than usual. Thus, the size of the antenna 1 as a whole is reduced.

If the length L2 of the ground pattern 2 is chosen in accordance with the center frequency 5.4 GHz of the 5 GHz band, characteristics in the 5 GHz band are improved. However, in the 2.4 GHz band, characteristics deteriorate since the length L2 of the ground pattern 2 is too short. More specifically, the impedance is deviated from 50 Ω, the antenna gain is reduced, and the resonant frequency is deviated. Thus, in this embodiment, the first parasitic element 3 is provided. The first parasitic element 3 has a length L8 of 13 mm, which is shorter than a quarter of the wavelength corresponding to the center frequency 2.45 GHz of the 2.4 GHz band. The sum of the length of the ground pattern 2 and the length of the first parasitic element 3 is shorter than a quarter of the wavelength corresponding to 2.45 GHz. This contributes to reduction in the size of the antenna 1. The width of the first parasitic element 3 is the same as the width L1 of the ground pattern 2. The first parasitic element 3 is not connected to other grounds.

In the dielectric substrate 10, the antenna element 12 for the 5 GHz band and the antenna element 11 for the 2.4 GHz band are provided. The dielectric substrate 10 is formed by laminating a plurality of dielectric layers and sintering the laminated dielectric layers. The antenna elements 12 and 11 are formed, for example, by printing silver paste in an internal dielectric layer. Thus, the shapes of the antenna element 12 for the 5 GHz band and the antenna element 11 for the 2.4 GHz band are not recognized as shown in FIG. 1A when viewed from the above. Alternatively, however, the dielectric substrate 10 may be formed by a single dielectric layer. In that case, the antenna element 12 for the 5 GHz band and the antenna element 11 for the 2.4 GHz band are formed on a top surface of the dielectric substrate 10, and are recognized as shown in FIG. 1A. The dielectric substrate 10 is disposed with a gap of approximately 1 mm from the ground pattern 2, and with a gap of approximately 1 mm from the first parasitic element 3.

The antenna element 12 for the 5 GHz band is connected to the core wire 5 of the coaxial cable 4 at the feeding point 12b on a side surface of the dielectric substrate 10. The antenna element 12 for the 5 GHz band has the shape of a reversed triangle having edges 12a and a top portion 12c, in which the distances of the edges 12a from an upper edge of the ground pattern 2 continuously increase. (To put it conversely, the shape is tapered toward the feeding point 12b.) The antenna element 12 for the 5 GHz band has a height L3 of approximately 2 mm. The height corresponds to the distance from a side edge of the dielectric substrate 10 to the top portion 12c. The antenna element 11 for the 2.4 GHz band has a T shape extending from the middle of the top portion 12c of the antenna element 12 for the 5 GHz band. In order to provide a sufficient length in a small area, the antenna element 11 for the 2.4 GHz band is branched in the middle and the branched portions are bent back toward the antenna element 12 for the 5 GHz band. The length L4 from a side edge of the dielectric substrate 10 to the edges of the bent-back portions of the antenna element 11 for the 2.4 GHz band is approximately 5 mm. For further reduction in size, the branched portions may be meandered. The edges of the antenna element 11 for the 2.4 GHz band and the top portion 12c of the antenna element 12 for the 5 GHz band are separated by a predetermined distance (approximately 3 mm in this embodiment) so that mutual interference will not occur.

The first parasitic element 3 is provided in association with the antenna element 11 for the 2.4 GHz band, opposite to the feeding point 12b, so as to cause capacitive coupling with the antenna element 11 for the 2.4 GHz band. Due to the capacitive coupling between the first parasitic element 3 and the antenna element 11 for the 2.4 GHz band, the antenna element 11 for the 2.4 GHz band causes excitation of the first parasitic element 3. The capacitive component and an inductive component caused by the length of the first parasitic element 3 cooperate so that the impedance is adjusted appropriately to 50 Ω.

The first parasitic element 3 is preferably disposed in proximity to the open end of the antenna element having a large excitation effect, i.e., in proximity to the open end of the antenna element 11 for the 2.4 GHz band. The open end refers to all the branched portions of the T-shaped antenna element 11 for the 2.4 GHz band. The proximity refers to a region within such a distance that excitation of the first parasitic element 3 is caused. Although the antenna element 11 for the 2.4 GHz band is provided on the upper-surface side of the substrate 8 in this embodiment, alternatively, the antenna element 11 for the 2.4 GHz band may be provided on the lower-surface side of the substrate 8 so as to oppose the first parasitic element 3.

FIG. 1B shows a side view of the antenna 1. As described above, on the upper surface of the substrate 8, the ground pattern 2, the dielectric substrate 10 including the antenna element 12 for the 5 GHz band and the antenna element 11 for the 2.4 GHz band, and the first parasitic element 3 are provided. The ground pattern 2 and the first parasitic element 3 need not necessarily be provided on the upper surface of the substrate 8, and a cover layer or the like may be provided over the ground pattern 2 and the first parasitic element 3. The first parasitic element 3 may be provided on the lower-surface side instead of the upper-surface side. The dielectric substrate 10 has a length L5 of 10 mm, a thickness of 1 mm, and a width of 4 mm.

On the lower-surface side of the substrate 8, the second parasitic element 7 is provided. The second parasitic element 7 need not necessarily be provided on the lower surface of the substrate 8 and can be provided on a cover layer such as a resist formed on the lower surface of the substrate 8 or on another substrate piled on the substrate 8. A cover layer or the like may be provided over the second parasitic element 7. The second parasitic element 7 overlaps a part of the ground pattern 2 and a part of the dielectric substrate 10 (e.g., a substantial or entire part of the antenna element 12 for the 5 GHz band). The second parasitic element 7 is provided for tuning of impedance characteristics in the 5 GHz band. By providing the second parasitic element 7 on the lower-surface side of the substrate 8 so as to overlap both the ground pattern 2 and the antenna element 12 for the 5 GHz band, impedance matching is achieved by a capacitive component attributable to coupling between the second parasitic element 7 and the antenna element 12 for the 5 GHz band of the dielectric substrate 10 and by an inductive component attributable to the length of the second parasitic element 7. As described above, the first parasitic element 3 contributes to resonance in the 2.4 GHz band together with the antenna element 11 for the 2.4 GHz band, and the second parasitic element 7 contributes to resonance in the 5 GHz band together with the antenna element 12 for the 5 GHz band. The antenna 1 has a thickness of 1.8 mm.

FIG. 1C is a rear view of the antenna 1. The substrate 8 has a length L7 of 39 mm, and the second parasitic element 7 has a length L6 of 11 mm. The substrate 8 and the second parasitic element 7 both have a width of 4 mm. The length L6 of the second parasitic element 7 is less than a quarter of the center frequency 5.4 GHz of the 5 GHz band. The second parasitic element 7 is not connected to other grounds.

The plane including the ground pattern 2, the plane including the antenna element 12 for the 5 GHz band and the antenna element 11 for the 2.4 GHz band, the plane including the first parasitic element 3, and the plane including the second parasitic element 7 are all parallel or substantially or nearly parallel to each other. The plane including the ground pattern 2, the plane including the antenna element 12 for the 5 GHz band and the antenna element 11 for the 2.4 GHz band, and the plane including the first parasitic element 3 may be all included in the same plane, some of these planes may be included in the same plane as shown in FIG. 1B, or these planes may be respectively included in different planes. That is, it suffices for the ground pattern 2, the antenna element 12 for the 5 GHz band, the antenna element 11 for the 2.4 GHz band, and the first parasitic element 3 to be provided in association with each other, i.e., so as to be aligned when viewed from the above, as shown in FIG. 1A. In some cases, these parts may partially overlap each other.

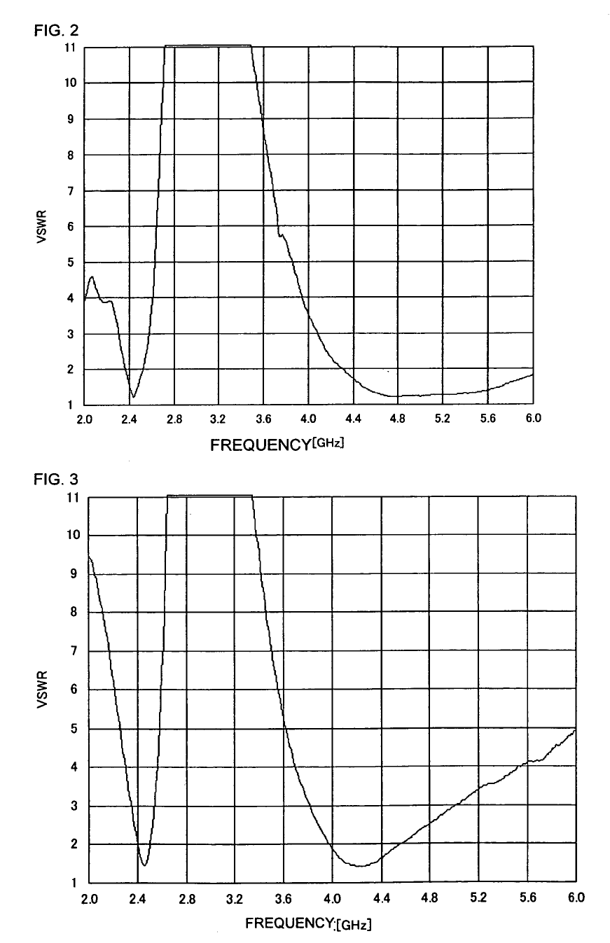

FIG. 2 shows frequency characteristics of the antenna 1 shown in FIGS. 1A to 1C. In FIG. 2, the vertical axis represents voltage standing wave ratio (VSWR), and the horizontal axis represents frequency in GHz. As shown in FIG. 2, VSWR is not larger than 2 in a range of approximately 2.4 GHz to 2.6 GHz. This is acceptable since a bandwidth about 100 MHz suffices in the 2.4 GHz band. In the 5 GHz band, VSWR is not larger than 2 in a range of 4.3 GHz to 6 GHz and even above. Since the operating frequency band is 4.9 GHz to 5.8 GHz, a sufficient bandwidth is provided in the 5 GHz band.

FIG. 3 shows frequency characteristics of the antenna 1 with the second parasitic element 7 removed therefrom. In FIG. 3, the vertical axis represents VSWR, and the horizontal axis represents frequency in GHz. In this case, in the 2.4 GHz band, VSWR is not larger than 2 in a frequency band of approximately 100 MHz between 2.4 GHz to 2.5 GHz, and the effect of the presence of the second parasitic element 7 is small. On the other hand, in the 5 GHz band, VSWR is not larger than 2 in a range of approximately 4.0 GHz to 4.6 GHz, which is considerably out of the operating frequency band. Furthermore, compared with FIG. 2, characteristics deteriorate in the operating frequency band. As described above, the second parasitic element 7 is effective only in the 5 GHz band, and serves to improve characteristics in the 5 GHz band.

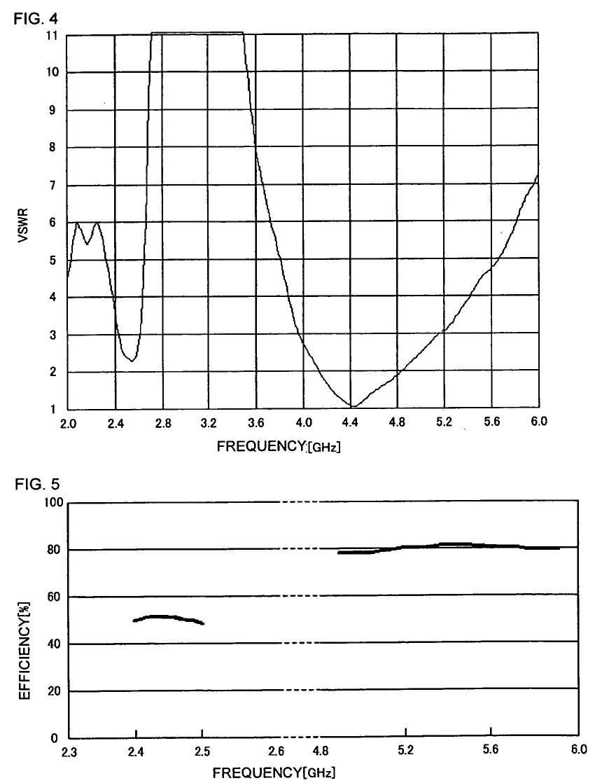

FIG. 4 shows frequency characteristics in a case where the first parasitic element 3 is further removed. In FIG. 4, the vertical axis represents VSWR, and the horizontal axis represents frequency in GHz. In this case, although characteristics somewhat change in the 5 GHz band, characteristics are still unfavorable in the operating frequency band. On the other hand, in the 2.4 GHz band, no band exists where VSWR is lower than 2. That is, the first parasitic element 3 is effective only in the 2.4 GHz band, and serves to improve characteristics in the 2.4 GHz band.

FIG. 5 shows frequency characteristics regarding the efficiency of the antenna 1 shown in FIGS. 1A to 1C. In FIG. 5, the vertical axis represents efficiency in %, and the horizontal axis represents frequency in GHz. The efficiency is measured for all directions. According to the measurement results, the efficiency of the antenna 1 is approximately 45% in the 2.4 GHz band, and is approximately 80% in the 5 GHz band. The efficiency in the 5 GHz band is very favorable.

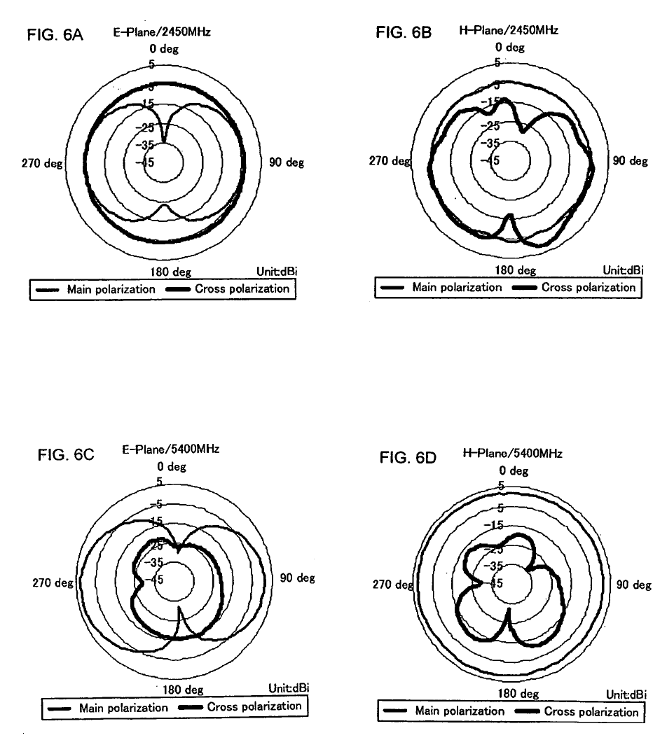

FIGS. 6A to 6D shows radiation directivity characteristics of the antenna 1. FIG. 6A shows radiation frequency characteristics at 2.45 GHz in the E plane. In FIG. 6A, a thin line represents characteristics regarding main polarization, having directivity centered at 90° and 270° and falling to approximately −35 dBi and −26 dBi at 0° and 180°, respectively. A thick line represents characteristics regarding cross polarization, having no directivity.

FIG. 6B shows radiation directivity characteristics at 2.45 GHz in the H plane. In FIG. 6B, a thin line represents characteristics regarding main polarization, having substantially no directivity. A thick line represents characteristics regarding cross polarization, which is complex but has directivity centered mainly at 90° and 180°.

FIG. 6C shows radiation directivity characteristics at 5.4 GHz in the E plane. In FIG. 6C, a thin line represents characteristics regarding main polarization, having directivity centered at 90° and 270° and falling to approximately −30 dBi and −43 dBi at 0° and 180°, respectively. A thick line represents characteristics regarding cross polarization, having directivity centered at 180° and partially falling to approximately −40 dBi at 270°.

FIG. 6D shows radiation directivity characteristics at 5.4 GHz in the H plane. In FIG. 6D, a thin line represents characteristics regarding main polarization, having no directivity. A thin line represents characteristics regarding cross polarization, which is complex but has directivity at approximately 40°, 150°, 220°, and 310°. As described above, the antenna 1 exhibits radiation directivity characteristics similar to those of an ordinary dipole antenna or monopole antenna.

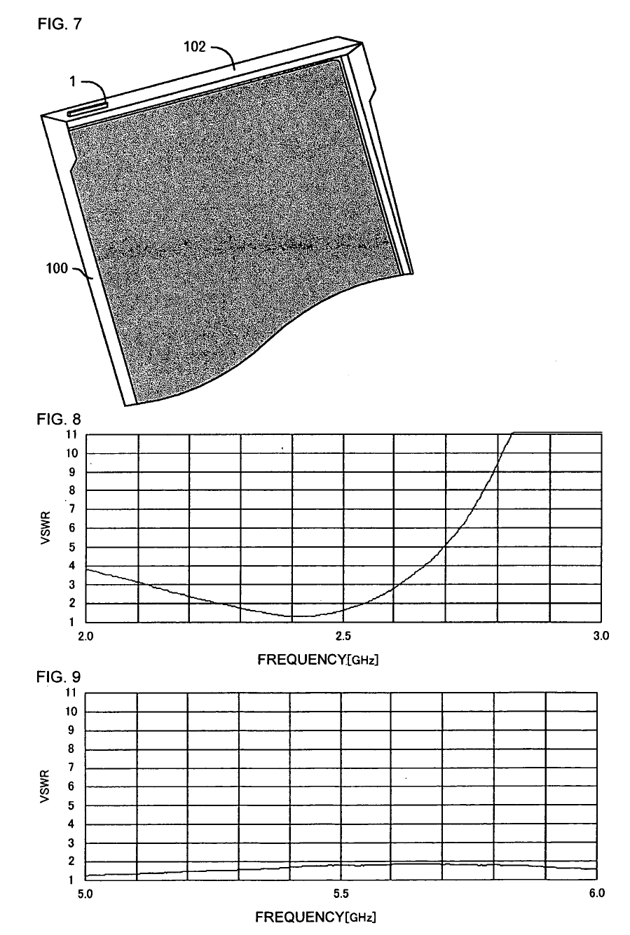

Next, the configuration of a notebook personal computer having mounted thereon the antenna 1 shown in FIGS. 1A to 1C will be described with reference to FIG. 7. FIG. 7 shows the notebook personal computer with a cover 100 including a liquid crystal display (LCD) panel opened. The antenna 1 is disposed on a surface 102 that comes to the top of the notebook personal computer with the cover 100 opened. In this embodiment, the antenna 1 is disposed on the surface 102 so that it is seen as shown in FIG. 1C with the LCD panel at the front. That is, the antenna 1 is disposed so that a side surface thereof is in contact with the surface 102. Alternatively, the antenna 1 may be disposed on the surface 102 so that it is seen as viewed in FIG. 1A. The antenna 1 is disposed on the cover 100 so as not to electrically contact metallic parts of the housing of the cover 100. In this embodiment, the ground of the antenna 1 is prevented from coming into contact with the frame of the LCD panel or the housing on the back surface of the LCD panel, which are usually composed of metal.

FIGS. 8 and 9 show characteristics of the antenna 1 mounted as described above. FIG. 8 shows frequency characteristics in the 2.4 GHz band, in which the vertical axis represents VSWR and the horizontal axis represents frequency in GHz. As shown in FIG. 8, VSWR is not larger than 2 in a range of 2.25 GHz to 2.55 GHz, which includes the operating frequency band and is sufficiently wide. FIG. 9 shows frequency characteristics in the 5 GHz band, in which the vertical axis represents VSWR and the horizontal axis represents frequency in GHz. As shown in FIG. 9, VSWR is not larger than 2 in a range of 5.0 GHz to 6.0 GHz. The curve indicates that VSWR is not larger than 2 also in a range of 0.1 GHz or wider below 5.0 GHz.

As described above, characteristics do not considerably change even when the antenna 1 is disposed at the top end of the cover 100 of the notebook personal computer, and the characteristics are practically acceptable.

As described above, the antenna 1 is disposed so that the ground thereof does not contact metallic parts of the cover 100. Since the characteristics of the antenna 1 as disposed on the cover 100 of the notebook personal computer is substantially the same as the characteristics of the antenna 1 itself, it is understood that the antenna 1 is less susceptible to the effects of metallic parts in the vicinity.

Conventionally, when an antenna is mounted on a notebook personal computer, a metallic plate antenna, a pattern antenna, a chip antenna, or the like, have been used. In either case, in order to attach an antenna, the ground of a housing is used as the ground of the antenna in order to achieve antenna characteristics needed. Thus, consideration as to how to achieve antenna characteristics needed is required when the material, shape, or mounting position of the housing changes. Thus, a considerable time is needed to achieve desired performance.

In contrast, according to the embodiment, even when the design of the housing of a radio communications device such as a notebook personal computer changes, when the mounting position of the antenna 1 changes, or when the material of the housing changes, the antenna configuration does not depend on characteristics of the housing. Thus, it is possible to use common configuration or common parts, so that time and energy needed to achieve desired antenna characteristics are reduced.

The present invention is not limited to the embodiment described above. For example, although a dual antenna has been described above, the present invention is not limited to application to a dual antenna, and may be applied to an antenna that supports only a single frequency band.

Although FIG. 7 shows an example where only the single antenna 1 is mounted on the cover 100 of the notebook personal computer, two or more antennas may be provided on the cover 100 to form a diversity antenna. Furthermore, although FIG. 7 shows an example where the antenna 1 is projected to the outside of the cover 100 for convenience of description, the antenna 1 may be mounted inside the cover 100.

Furthermore, instead of the notebook personal computer, the antenna 1 may be mounted on other types of portable information devices. Also in that case, the antenna 1 can be mounted so that the ground thereof is not connected to metallic parts of the portable information devices.

This application claims priority under 35 U.S.C. § 119 to Japanese Patent Application No. 2004-032994, filed on Feb. 10, 2004, the disclosure of which is herein incorporated by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

1. An antenna comprising:
an antenna element for use at a predetermined frequency band;
a ground pattern juxtaposed with the antenna element at feeding-point side of the antenna element, the ground pattern having a length, along a longitudinal direction, less than a quarter of a wavelength corresponding to the predetermined frequency band; and
a parasitic element provided in proximity to the antenna element.

2. The antenna according to claim 1, wherein the parasitic element has a length, along a longitudinal direction, less than a quarter of a wavelength corresponding to the predetermined frequency band.

3. An antenna comprising:
a substrate having a first surface and a second surface opposite to the first surface;
an antenna element for use at a predetermined frequency band, provided on the first surface of the substrate;
a ground pattern provided on the first surface of the substrate, the ground pattern juxtaposed with the antenna element on a feeding-point side of the antenna element; and
a parasitic element provided on the second surface of the substrate so as to overlap both the antenna element and the ground pattern.

4. The antenna according to claim 3, wherein the parasitic element has a length, along a longitudinal direction, less than a quarter of a wavelength corresponding to the predetermined frequency band.

5. The antenna according to claim 3, wherein the ground pattern has a length, along a longitudinal direction, equivalent to a quarter of a wavelength corresponding to the predetermined frequency band.

6. An antenna comprising:
a first antenna element for use at a first frequency band;
a second antenna element for use at a second frequency band that is lower than the first frequency band, the second antenna element being connected to the first antenna element;
a ground pattern juxtaposed with the first antenna element at a feeding-point side of the first antenna element, the ground pattern having a length, along a longitudinal direction, equivalent to a quarter of a wavelength corresponding to the first frequency band; and
a first parasitic element provided in proximity to the second antenna element.

7. The antenna according to claim 6, further comprising:
a substrate having a first surface and a second surface opposite to the first surface, the first antenna element, the second antenna element, and the ground pattern being provided on the first surface of the substrate; and
a second parasitic element provided on the second surface of the substrate so as to overlap both the first antenna element and the ground pattern.

8. The antenna according to claim 6, wherein the first parasitic element has a length, along a longitudinal direction, less than a quarter of a wavelength corresponding to the second frequency band.

9. The antenna according to claim 7, wherein the second parasitic element has a length, along a longitudinal direction, less than a quarter of a wavelength corresponding to the first frequency band.

10. An antenna comprising:
a first antenna element for use at a first frequency band, said first antenna element being constituted by a linear element;
a second antenna element for use at a second frequency band that is lower than the first frequency band, said second antenna element being constituted by a tabular element and connected to the first antenna element;
a ground pattern juxtaposed with the first antenna element at a feeding-point side of the first antenna element;
a first parasitic element provided in proximity to the second antenna element to together contribute to resonance in the first frequency band; and
optionally a second parasitic element provided in proximity to the first antenna element to together contribute to resonance in the second frequency band, said second parasitic element overlapping a portion of the ground pattern and at least a portion of the first antenna element.

11. The antenna according to claim 10, wherein the second parasitic element is provided and overlaps a substantial or entire portion of the first antenna element.

12. The antenna according to claim 10, wherein the ground pattern has a length, along a longitudinal direction, equivalent to approximately a quarter of a wavelength corresponding to the first frequency band.

13. The antenna according to claim 10, wherein the first parasitic element has a length, along a longitudinal direction, less than a quarter of a wavelength corresponding to the second frequency band.

14. The antenna according to claim 10, wherein the first antenna element and the second antenna element are printed or formed on a dielectric substrate.

15. The antenna according to claim 10, wherein the first frequency band is the 5 GHz band, and the second frequency band is the 2.4 GHz band.

16. The antenna according to claim 10, further comprising a substrate, wherein the first and second antenna elements, the ground pattern, and the first parasitic element are disposed on a front side of the substrate, whereas the second parasitic element is optionally disposed on a back side of the substrate.

17. A wireless communications device comprising the antenna of claim 1, wherein the ground pattern is separated from a ground of a housing of the wireless communications device.

18. A wireless communications device comprising the antenna of claim 3, wherein the ground pattern is separated from a ground of a housing of the wireless communications device.

19. A wireless communications device comprising the antenna of claim 6, wherein the ground pattern is separated from a ground of a housing of the wireless communications device.

20. A wireless communications device comprising the antenna of claim 10, wherein the ground pattern is separated from a ground of a housing of the wireless communications device.
